(19) United States
(12) Patent Application Publication
(10) Pub. No.: US 2024/0244998 A1
(43) Pub. Date: Jul. 25, 2024

(54) AGRICULTURAL HARVESTERS, NON-TRANSITORY COMPUTER-READABLE MEDIA AND METHODS FOR RESIDUE SPREAD CONTROL

(71) Applicant: Deere & Company, Moline, IL (US)

(72) Inventors: Nathan R. VANDIKE, Geneseo, IL (US); Benjamin Peschel, Contwig (DE)

(73) Assignee: Deere & Company, Moline, IL (US)

(21) Appl. No.: 18/158,739

(22) Filed: Jan. 24, 2023

(51) Int. Cl. A01D 41/127

(52) U.S. Cl. CPC A01D 41/127

(57) ABSTRACT

Provided is an agricultural harvester including a spreader, and processing circuitry configured to cause the agricultural harvester to obtain a residue spread variance (RSV) of a first residue spread in a first harvesting area, the RSV corresponding to a distance between an edge of the first residue and a first position of a cut edge of the first harvesting area, and the RSV being obtained before the spreader reaches the first position, adjust an operation parameter of the agricultural harvester based on the RSV to obtain an adjusted operation parameter, and control the agricultural harvester in a second harvesting area according to the adjusted operation parameter, the second harvesting area being adjacent to the first harvesting area, and the control of the agricultural harvester according to the adjusted operation parameter causing the spreader to spread a second residue at the first position to compensate for the RSV.

### FIELD

Some example embodiments provide agricultural harvesters, non-transitory computer-readable media and methods for residue spread variance compensation.

### BACKGROUND

There are a wide variety of different types of agricultural machines. Some agricultural machines include harvesters, such as combine harvesters, sugar cane harvesters, cotton harvesters, self-propelled forage harvesters, and windrowers. Some harvesters may be fitted with different types of heads to harvest different types of crops.

As a harvester travels across and completes a harvesting operation, the byproducts from the harvesting operation, called material other than grain (MOG), are dispersed by the agricultural harvester across the field.

### SUMMARY

Some example embodiments provide an agricultural harvester including a spreader, and processing circuitry configured to cause the agricultural harvester to obtain a residue spread variance of a first residue spread in a first harvesting area, the residue spread variance corresponding to a distance between an edge of the first residue and a first position of a cut edge of the first harvesting area, and the residue spread variance being obtained before the spreader reaches the first position, adjust an operation parameter of the agricultural harvester based on the residue spread variance to obtain an adjusted operation parameter, and control the agricultural harvester in a second harvesting area according to the adjusted operation parameter, the second harvesting area being adjacent to the first harvesting area, and the control of the agricultural harvester according to the adjusted operation parameter causing the spreader to spread a second residue at the first position to compensate for the residue spread variance.

Some example embodiments provide a non-transitory computer-readable medium storing instructions that, when executed by at least one processor of an agricultural harvester, cause the at least one processor to perform a method, the method including obtaining a residue spread variance of a first residue spread in a first harvesting area, the residue spread variance corresponding to a distance between an edge of the first residue and a first position of a cut edge of the first harvesting area, and the residue spread variance being obtained before a spreader of the agricultural harvester reaches the first position, adjusting an operation parameter of the agricultural harvester based on the residue spread variance to obtain an adjusted operation parameter, and controlling the agricultural harvester in a second harvesting area according to the adjusted operation parameter, the second harvesting area being adjacent to the first harvesting area, and the controlling causing the spreader to spread a second residue at the first position to compensate for the residue spread variance.

Some example embodiments provide a method performed by an agricultural harvester, the method including obtaining a residue spread variance of a first residue spread in a first harvesting area, the residue spread variance corresponding to a distance between an edge of the first residue and a first position of a cut edge of the first harvesting area, and the residue spread variance being obtained before a spreader of the agricultural harvester reaches the first position, adjusting an operation parameter of the agricultural harvester based on the residue spread variance to obtain an adjusted operation parameter, and controlling the agricultural harvester in a second harvesting area according to the adjusted operation parameter, the second harvesting area being adjacent to the first harvesting area, and the controlling causing the spreader to spread a second residue at the first position to compensate for the residue spread variance.

Some example embodiments provide an agricultural harvester including a spreader, obtaining means to obtain a residue spread variance of a first residue spread in a first harvesting area, the residue spread variance corresponding to a distance between an edge of the first residue and a first position of a cut edge of the first harvesting area, and the residue spread variance being obtained before the spreader reaches a second position in a second harvesting area, the second harvesting area being adjacent to the first harvesting area, and the first position being aligned with the second position, adjusting means to adjust an operation parameter of the agricultural harvester based on the residue spread variance to obtain an adjusted operation parameter, and controlling means to control the agricultural harvester in the second harvesting area according to the adjusted operation parameter, the control of the agricultural harvester according to the adjusted operation parameter causing the spreader to spread a second residue at the second position to compensate for the residue spread variance.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 is a partial pictorial, partial schematic illustration of a self-propelled agricultural harvester 100, according to some example embodiments;

FIG. 2 illustrates a flow chart of a method for adjusting a residue spread to compensate for a residue spread variance, according to some example embodiments;

FIG. 3 illustrates a diagram showing a residue compensation operation, according to some example embodiments;

FIG. 4A illustrates a table 400A containing associations between respective residue spread variance values and corresponding operation parameter adjustments, according to some example embodiments;

FIG. 4B illustrates a table 400B containing associations between operation parameter adjustments and both residue spread variance values and environmental parameters, according to some example embodiments;

FIG. 5A illustrates a flowchart of a method for obtaining a residue spread variance by determining a distance between a residue spread width and a cut edge using forward-looking sensors, according to some example embodiments;

FIG. 5B illustrates a diagram showing the determining performed using the forward-looking sensors, according to some example embodiments;

FIG. 6A illustrates a flowchart of a method for obtaining a residue spread variance using a residue spread variance map, according to some example embodiments;

FIG. 6B illustrates a diagram showing the generation and use of the residue spread variance map, according to some example embodiments;

FIG. 7A illustrates a flowchart of a collaborative method for obtaining a residue spread variance, according to some example embodiments;

FIG. 7B illustrates a diagram showing determining and communication of the residue spread variance, according to some example embodiments; and

FIG. 8 is a diagram of a system for adjusting a residue spread to compensate for a residue spread variance, according to some example embodiments.

### DETAILED DESCRIPTION

Uniform residue spreading may increase the overall production of a field. Non-uniform residue coverage causes a variety of different challenges. For instance, nutrients in the residue will be concentrated under the bands of high residue. Or for instance, pests such as insects, slugs, and rodents reside in larger residue piles. Or for instance, weed seeds and grain lost through the combine will be concentrated in the residue patches. Or for instance, herbicide effectiveness will be compromised because the herbicides are blocked from reaching the soil by residue patches. Or for instance, windrows or piles of residue may reduce performance of a planter because the seed openers have difficulty cutting through excessive residue, and seeds are not planted in the soil. Or for instance, non-uniform residue coverage may also cause non-uniform soil temperature and moisture conditions. The soil covered by greater amounts of residue will be several degrees cooler and will be more moist than bare soil causing differences in crop development. Or for instance, residue spread farther than a cut edge of a row (e.g., farther than a width of a header of the agricultural harvester) may collect on a crop of the adjacent row. Subsequently, when the adjacent row is harvested, the collected residue in combination with the crop of the adjacent row provides an excessive amount of vegetation to be cut by the header, resulting in the vegetation becoming compacted in a corner of the header. This compacted vegetation may result in delay in clearing the compacted vegetation from the header, reduced harvesting performance, and/or damage to the header.

Performance of a residue spreader on an agricultural harvester may be deleteriously affected based on a number of different criteria. For example, areas with variance in vegetation such as intensity of weeds or crop plants may have deleterious effects on the residue spreading operation. Increased vegetation may increase the mass of residue being spread by the agricultural harvester.

Or for example, topographic characteristics affect the orientation of the agricultural harvester (e.g., pitch and roll) as it travels over the terrain. This orientation of the agricultural harvester affects the way in which the harvester spreads residue across the field. For instance, when agricultural harvester rolls to either the left or right side, the uphill side may have a shorter residue spread distance.

Or for example, areas with variance in vegetation moisture, such as moisture in the weed and crop plants, may have deleterious effects on the residue spreading operation. For instance, material having a higher moisture may spread in a smaller width due to increased friction in the residue system or due to the increased mass of the material. Or in some instances, material having a higher moisture may spread farther because of increased inertia of the material that resists the effects of air resistance or wind.

Or for example, wind may affect residue spread operations. For instance, a crosswind with respect to a travel direction of the agricultural harvester may shift a residue spread in a lateral direction. Also, a wind blowing in a direction parallel to the travel direction of the agricultural harvester may shift a residue spread along the direction parallel to the travel direction of the agricultural harvester. The extent of the shift in residue spread due to wind may be proportional to a strength of the wind.

At least the above sources of deleterious performance, for example, may negatively affect a spread width of a residue spreader resulting in a failure to spread a residue to a cut edge of a harvesting area (e.g., an edge of a row in a field between a cut crop and an uncut crop), which may be referred to herein as a residue spread variance. For example, the spread of the residue may fall short of the cut edge, or in some circumstances (e.g., an uncut crop of less density), the residue may be spread beyond the cut edge. Conventional devices and methods may detect a residue spread variance in a first harvesting area, and adjust a setting of the agricultural harvester to increase a residue spread width in a second harvesting area in order to avoid or reduce the residue spread variance in the second harvesting area. However, the conventional devices and methods fail to adequately compensate for the residue spread variance of the first harvesting area. Accordingly, the conventional devices and methods are unable to provide adequate residue spread performance in the first harvesting area.

However, according to some example embodiments, improved devices and methods are provided for residue spreading. For example, the improved devices and methods may determine a residue spread variance in a first harvesting area adjacent to a second harvesting area (e.g., in an adjacent row of the field). The residue spread variance may indicate (e.g., may include), for example, a distance between (1) an outer edge of a spread width in the first harvesting area and (2) a cut edge of the first harvesting area. The improved devices and methods may adjust a spread width of an agricultural harvester spreading residue in the second harvesting area to compensate for the residue spread variance of the first harvesting area by, for example, (1) extending a spread width of the agricultural harvester beyond the second harvesting area and into the first harvesting area, or (2) reducing the spread width of the agricultural harvester such that the residue is spread short of the cut edge in the second harvesting area.

Also, the improved devices and methods may proactively determine the first harvest area residue spread variance at locations in front of the agricultural harvester (e.g., in front of a spreader of the harvester) in the second harvesting area, thereby permitting time for the adjustment of the spread width before the agricultural harvester (e.g., the spreader) reaches the locations. In so doing, the improved devices and methods may provide a more accurate adjustment of the spread width to better compensate for the residue spread variance of the first harvesting area. Accordingly, the improved devices and methods overcome the deficiencies of the conventional devices and methods to at least compensate for a residue spread variance of an adjacent harvesting area through accurate adjustment of a spread width of an agricultural harvester spreader to at least improve a residue spread performance in the harvesting areas.

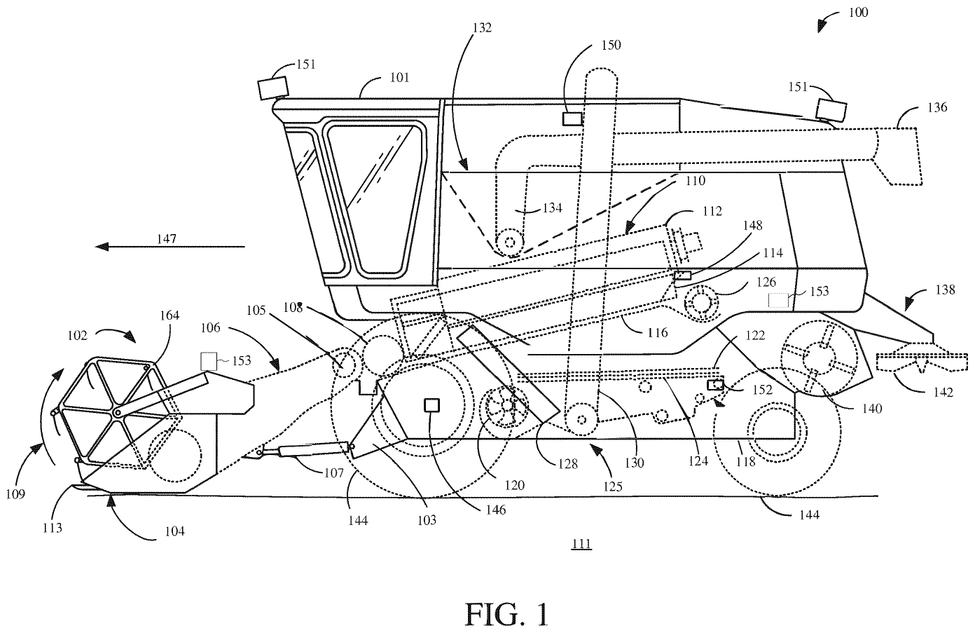

FIG. 1 is a partial pictorial, partial schematic illustration of a self-propelled agricultural harvester 100 (may also be referred to herein as an agricultural machine 100), according to some example embodiments. In the illustrated example, the agricultural harvester 100 is a combine harvester. Further, although combine harvesters are provided as examples throughout the present disclosure, it will be appreciated that the present description is also applicable to other types of harvesters, such as cotton harvesters, sugarcane harvesters, self-propelled forage harvesters, windrowers, or other agricultural work machines. Consequently, the present disclosure is intended to encompass the various types of harvesters described and is, thus, not limited to combine harvesters.

As shown in FIG. 1, the agricultural harvester 100 illustratively includes an operator compartment 101, which may have a variety of different operator interface mechanisms for controlling the agricultural harvester 100. The agricultural harvester 100 may include front-end equipment, such as a header 102, and a cutter generally indicated at 104. In the illustrated example, the cutter 104 is included on the header 102. The agricultural harvester 100 may also include a feeder house 106, a feed accelerator 108, and/or a thresher generally indicated at 110. The feeder house 106 and the feed accelerator 108 may form part of a material handling subsystem 125. The header 102 may be pivotally coupled to a frame 103 of the agricultural harvester 100 along a pivot axis 105. One or more actuators 107 (may be referred to herein in singular or plural form) may drive movement of the header 102 about the axis 105 in the direction generally indicated by an arrow 109. Thus, a vertical position of the header 102 (the header height) above ground 111 over which the header 102 travels is controllable by actuating the actuator 107. While not shown in FIG. 1, the agricultural harvester 100 may also include one or more actuators that operate to apply a tilt angle, a roll angle, or both to the header 102 or portions of the header 102. Tilt refers to an angle at which the cutter 104 engages the crop. The tilt angle is increased, for example, by controlling the header 102 to point a distal edge 113 of the cutter 104 more toward the ground 111. The tilt angle may be decreased by controlling the header 102 to point the distal edge 113 of the cutter 104 more away from the ground 111. The roll angle refers to the orientation of the header 102 about the front-to-back longitudinal axis of the agricultural harvester 100.

The thresher 110 illustratively includes a threshing rotor 112 and a set of concaves 114. Further, the agricultural harvester 100 may also include a separator 116. The agricultural harvester 100 may also include a cleaning subsystem or cleaning shoe (collectively referred to as cleaning subsystem 118) that may include a cleaning fan 120, a chaffer 122, and/or a sieve 124. The material handling subsystem 125 may also include a tailings elevator 128 and/or a clean grain elevator 130, as well as an unloading auger 134 and/or a spout 136. The clean grain elevator 130 may move clean grain into a clean grain tank 132. The agricultural harvester 100 may also include a residue subsystem 138 that may include a discharge beater 126, a chopper 140 and/or a spreader 142. The agricultural harvester 100 may also include a propulsion subsystem that may include an engine that drives ground engaging components 144, such as wheels or tracks. In some examples, a combine harvester within the scope of the present disclosure may have more than one of any of the subsystems mentioned above. In some examples, the agricultural harvester 100 may have left and right cleaning sub systems, separators, etc., which are not shown in FIG. 1.

In operation, and by way of overview, the agricultural harvester 100 illustratively moves through a field in the direction indicated by arrow 147. As the agricultural harvester 100 moves, the header 102 (and an associated reel 164) may engage the crop to be harvested and gather the crop toward the cutter 104. An operator of the agricultural harvester 100 may be a local human operator, a remote human operator, and/or an automated system. An operator command is a command by an operator. The operator of the agricultural harvester 100 may determine one or more of a height setting, a tilt angle setting, and/or a roll angle setting for the header 102. For example, the operator may input a setting or settings to a control system, described in more detail below, that controls the actuator 107. The control system may also receive a setting from the operator for establishing the tilt angle and/or roll angle of the header 102 and implement the inputted settings by controlling associated actuators, not shown, that operate to change the tilt angle and/or roll angle of the header 102. The actuator 107 may maintain the header 102 at a height above the ground 111 based on a height setting and, where applicable, at desired tilt and/or roll angles. Each of the height, roll, and tilt settings may be implemented independently of the others. The control system may respond to header error (e.g., the difference between the height setting and measured height of the header 102 above the ground 111 and, in some examples, tilt angle and/or roll angle errors) with a responsiveness that is determined based on a selected sensitivity level. If the sensitivity level is set at a greater level of sensitivity, the control system may respond to smaller header position errors, and attempt to reduce the detected errors more quickly than when the sensitivity is at a lower level of sensitivity.

Returning to the description of the operation of the agricultural harvester 100, after crops are cut by cutter 104, the severed crop material may be moved through a conveyor in the feeder house 106 toward the feed accelerator 108, which accelerates the crop material into the thresher 110. The crop material may be threshed by the threshing rotor 112 rotating the crop against the concaves 114. The threshed crop material may be moved by a separator rotor in the separator 116 where a portion of the residue may be moved by the discharge beater 126 toward the residue subsystem 138. The portion of residue transferred to the residue subsystem 138 may be chopped by the chopper 140 and spread on the field by the spreader 142. In other configurations, the residue may be released from the agricultural harvester 100 in a windrow. In other examples, the residue subsystem 138 may include weed seed eliminators (not shown) such as seed baggers or other seed collectors, or seed crushers or other seed destroyers.

Grain may fall to the cleaning subsystem 118. The chaffer 122 may separate some larger pieces of material from the grain, and the sieve 124 may separate some finer pieces of material from the clean grain. The clean grain may fall to an auger that may move the grain to an inlet end of the clean grain elevator 130, and the clean grain elevator 130 may move the clean grain upwards, depositing the clean grain in the clean grain tank 132. Residue may be removed from the cleaning subsystem 118 by airflow generated by the cleaning fan 120. The cleaning fan 120 may direct air along an airflow path upwardly through the sieves and chaffers. The airflow may carry residue rearwardly in the agricultural harvester 100 toward the residue subsystem 138.

The tailings elevator 128 may return tailings to the thresher 110 where the tailings are re-threshed. Alternatively, the tailings also may be passed to a separate re-threshing mechanism by a tailings elevator or another transport device where the tailings are re-threshed as well.

FIG. 1 also shows that, in one example, the agricultural harvester 100 may include a machine speed sensor 146, one or more separator loss sensors 148, a clean grain camera 150, a forward/rearward looking image capture mechanism 151, which may be in the form of a stereo or mono camera, one or more loss sensors 152 provided in the cleaning subsystem 118, and/or at least one sideways looking image capture mechanism 153 (may also be in the form of a stereo or mono camera).

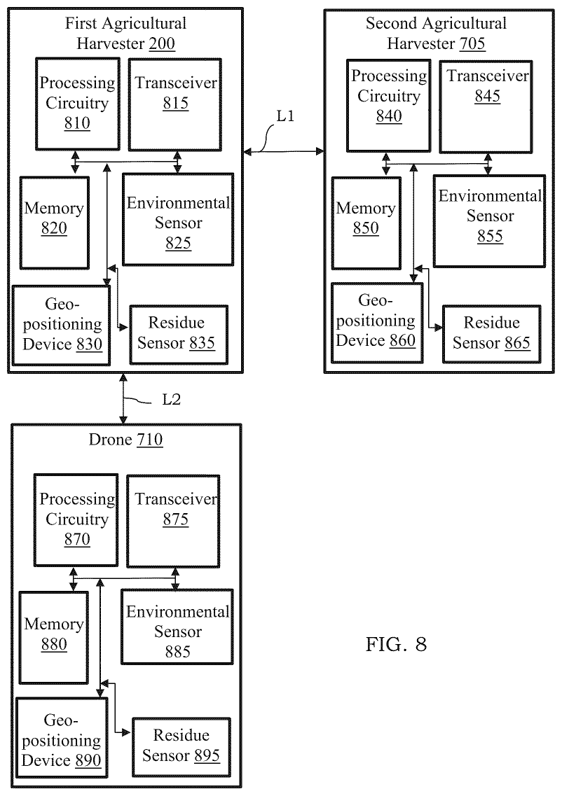

The machine speed sensor 146 may sense the travel speed of the agricultural harvester 100 over the ground 111. The machine speed sensor 146 may sense the travel speed of the agricultural harvester 100 by sensing the speed of rotation of the ground engaging components (such as wheels or tracks), a drive shaft, an axel, or other components. In some instances, the travel speed may be sensed using a positioning system, such as a global positioning system (GPS), a dead reckoning system, a long range navigation (LORAN) system, or a wide variety of other systems or sensors that provide an indication of travel speed. According to some example embodiments, the geo-positioning device 830, the geo-positioning device 860 and/or the geo-positioning device 890, discussed below in connection with FIG. 8, may be implemented using the positioning system.

The loss sensors 152 illustratively provide an output signal indicative of the quantity of grain loss occurring in both the right and left sides of the cleaning subsystem 118. In some examples, the loss sensors 152 are strike sensors which count grain strikes per unit of time or per unit of distance traveled to provide an indication of the grain loss occurring at the cleaning subsystem 118. The strike sensors for the right and left sides of the cleaning subsystem 118 may provide individual signals or a combined or aggregated signal. In some examples, the loss sensors 152 may include a single sensor as opposed to separate sensors provided for each side of the cleaning subsystem 118. The separator loss sensors 148 may provide a signal indicative of grain loss in the left and right separators, not separately shown in FIG. 1. The separator loss sensors 148 may be associated with the left and right separators and may provide separate grain loss signals or a combined or aggregate signal. In some instances, sensing grain loss in the separators may also be performed using a wide variety of different types of sensors as well.

The agricultural harvester 100 may also include other sensors and measurement mechanisms. For instance, the agricultural harvester 100 may include one or more of the following sensors: a header height sensor that senses a height of the header 102 above the ground 111; stability sensors that sense oscillation or bouncing motion (and amplitude) of the agricultural harvester 100; a residue setting sensor that is configured to sense whether the agricultural harvester 100 is configured to chop the residue, produce a windrow, etc.; one or more sensors for detecting a residue spread performance of the agricultural harvester 100 or of another agricultural harvester (e.g., at least one camera, a Radar system, a Lidar system, etc.); a cleaning shoe fan speed sensor to sense the speed of the cleaning fan 120; a concave clearance sensor that senses clearance between the threshing rotor 112 and the concaves 114; a threshing rotor speed sensor that senses a rotor speed of the threshing rotor 112; a chaffer clearance sensor that senses the size of openings in the chaffer 122; a sieve clearance sensor that senses the size of openings in the sieve 124; a material other than grain (MOG) moisture sensor that senses a moisture level of the MOG passing through the agricultural harvester 100; one or more machine setting sensors configured to sense various configurable settings of the agricultural harvester 100; a machine orientation sensor that senses the orientation of the agricultural harvester 100; and/or crop property sensors that sense a variety of different types of crop properties, such as crop type, crop moisture, and/or other crop properties. Crop property sensors may also be configured to sense characteristics of the severed crop material as the crop material is being processed by the agricultural harvester 100. For example, in some instances, the crop property sensors may sense grain quality such as broken grain, MOG levels; grain constituents such as starches and protein; and/or grain feed rate as the grain travels through the feeder house 106, the clean grain elevator 130, or elsewhere in the agricultural harvester 100. The crop property sensors may also sense the feed rate of biomass through the feeder house 106, through the separator 116 or elsewhere in the agricultural harvester 100. The crop property sensors may also sense the feed rate as a mass flow rate of grain through the clean grain elevator 130 or through other portions of the agricultural harvester 100 or provide other output signals indicative of other sensed variables. According to some example embodiments, the at least one environmental sensor 825, the one or more residue sensors 835, the at least one environmental sensor 855, the one or more residue sensors 865, the at least one environmental sensor 885 and/or the one or more residue sensors 895, as discussed in connection with FIG. 8, may each include one or more of the sensors discussed above as included in the agricultural harvester 100.

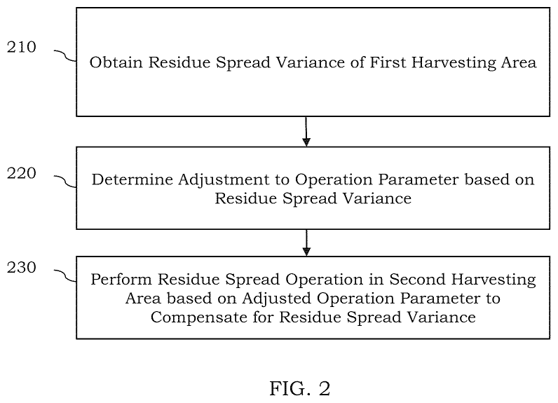

FIG. 2 illustrates a flow chart of a method for residue compensation of a previous harvesting area, according to some example embodiments. The below operations of the method are described as being performed by an agricultural harvester 200, which may be implemented by the agricultural harvester 100 discussed in connection with FIG. 1. For example, the operations described herein as being performed using processing circuitry of the agricultural harvester 200 (e.g., the control system discussed above in connection with FIG. 1, for instance, the processing circuitry 810 discussed in association with FIG. 8), but some example embodiments are not limited thereto. According to some example embodiments, at least some of the operations described herein as being performed by the agricultural harvester 200 (and/or operations described herein as being performed by another agricultural harvester 100) may be performed using processing circuitry remote from the agricultural harvester 200 (and/or the other agricultural harvester 100) (e.g., an external server). The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

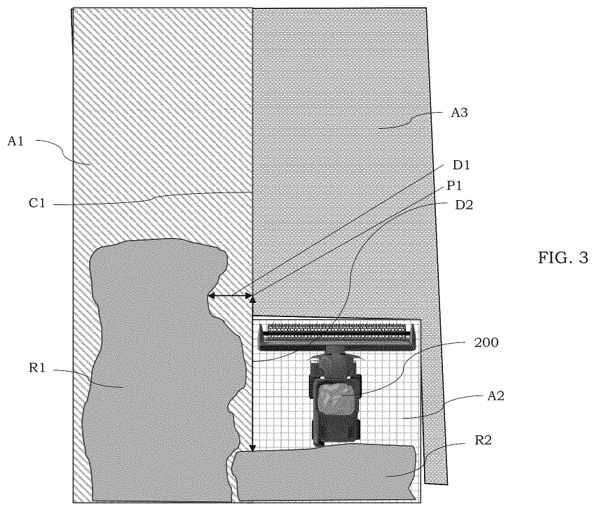

At operation 210, the agricultural harvester 200 may obtain a residue spread variance of a first harvesting area adjacent to a second harvesting area. With reference to FIG. 3, illustrating a diagram showing a residue compensation operation, according to some example embodiments, the agricultural harvester 200 may obtain a distance D1 corresponding to a residue spread variance of a first harvesting area A1 adjacent to a second harvesting area A2 at a first position P1. According to some example embodiments, the distance D1 may be a distance between a cut edge C1 of the first harvesting area A1 and an edge of a spread width of a first residue R1 in the first harvesting area A1 (also referred to herein as a first distance D1), however some example embodiments are not limited thereto. According to some example embodiments, the distance D1 may be a distance between the edge of the spread width of the first residue R1 in the first harvesting area A1 and the agricultural harvester 200 (e.g., the spreader 142 of the agricultural harvester 200). As shown in FIG. 3, the first distance D1 is indicative of the residue spread variance of the first residue R1. As such, the residue spread variance may correspond to the first distance D1. The cut edge C1 may be indicative of an edge between a harvested crop in the first harvesting area A1 and an unharvested crop in a third harvesting area A3 (and/or the harvested crop in the second harvesting area A2).

A width of a harvesting area (e.g., the first harvesting area A1 corresponding to a first row in a field) may correspond to a width of the header 102 of the agricultural harvester 200. The spread width of a residue (e.g., the first residue R1) may vary from the width of the harvesting area (e.g., the first harvesting area A1) in response to the effects of environmental conditions including, for example, a wind (e.g., wind strength, wind direction/cross wind, etc.), a terrain (e.g., side slope, pitch, etc.), a feedrate (e.g., varying according to a speed of the agricultural harvester 200, a height of the header 102, a type of crop in the first harvesting area A1), and/or a moisture of the crop. While FIG. 3 illustrates the spread width of the first residue R1 as being short of the cut edge C1, some example embodiments are not limited thereto. According to some example embodiments, the spread width of the first residue R1 may extend beyond the cut edge C1 (e.g., in fields in which a crop is less dense permitting the residue to fall through the crop rather than collect at the cut edge) in which case the distance D1 may measure a distance the spread width of the first residue R1 extends into the second harvesting are A2 (e.g., represented as a negative distance D1, a distance between the agricultural harvester 200 and the edge of the spread width of the first residue R1, etc.). According to some example embodiments, the first harvesting area A1 may be harvested by, and the first residue R1 spread by, the agricultural harvester 200 that harvests the second harvesting area A2 (and spreads a second residue R2) or by another agricultural harvester 100.

According to some example embodiments, the residue spread variance obtained by the agricultural harvester 200 may include a plurality of distances D1 respectively corresponding to respective distances between the cut edge C1 and the edge of the spread width of the first residue R1 (e.g., a crop residue, such as, MOG) along a length of the cut edge C1 parallel, or substantially parallel, to a row in a field (e.g., the first row in the field including the first harvesting area A1). According to some example embodiments, the residue spread variance may include a continuous curve indicative of the varying distances D1 between the cut edge C1 and the edge of the spread width of the first residue R1.

Referring to FIGS. 2 and 3, in operation 210, the agricultural harvester 200 may obtain (e.g., determine, calculate, sense, receive, etc.) the residue spread variance corresponding to the first position P1 of the cut edge C1 in front of the agricultural harvester 200 (e.g., with respect to a travel direction of the agricultural harvester 200 along a second row of the field including the second harvesting area A2), before the agricultural harvester 200 (e.g., before the spreader 142 of the agricultural harvester 200) reaches the first position P1. For example, the agricultural harvester 200 may obtain the residue spread variance corresponding to the first position P1 when the first position P1 is at least a threshold distance away from the agricultural harvester 200 and/or the spreader 142. With reference to FIG. 3, the first position P1 may be a distance D2 from the spreader 142. The distance D2 may be greater than or equal to the threshold distance. By obtaining the residue spread variance of the first position P1 at a time when the first position P1 is at least the threshold distance from the agricultural harvester 200 and/or the spreader 142, the agricultural harvester 200 is provided with sufficient time to compute an adjustment to a second residue spread R2 of the agricultural harvester 200 to accurately compensate for the residue spread variance at the first position P1. According to some example embodiments, the threshold distance may be computed based on (1) an amount of time taken to compute the adjustment and adjust one or more operation parameters of the agricultural harvester 200, and (2) a travel speed of the agricultural harvester 200.

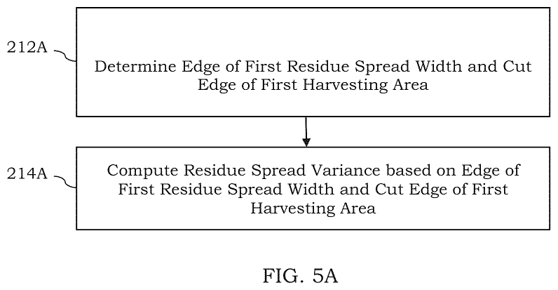

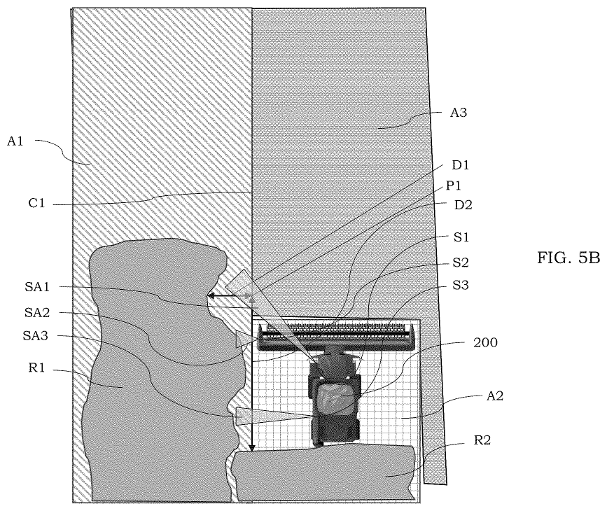

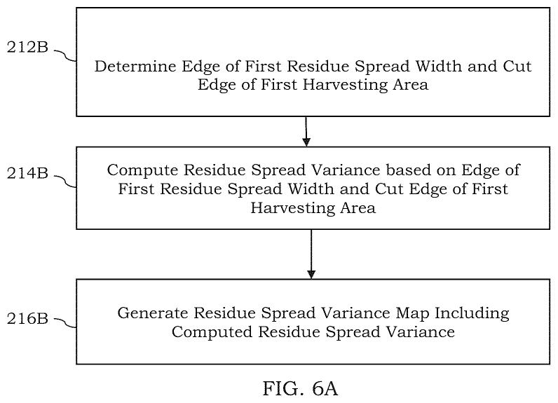

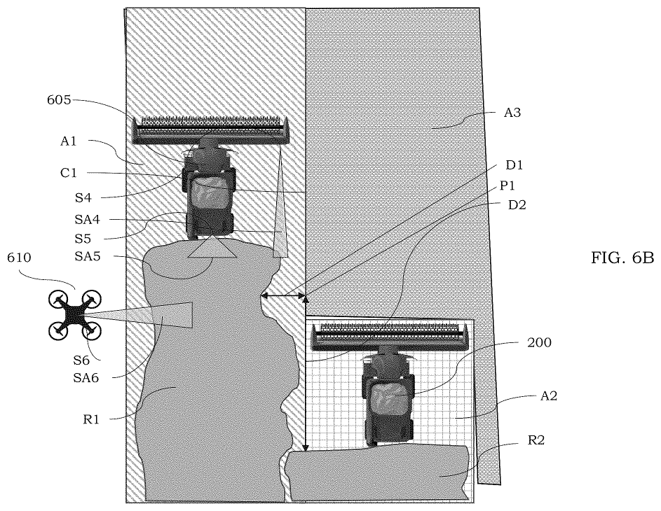

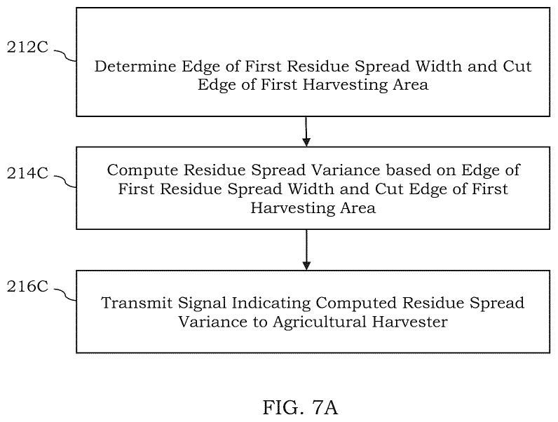

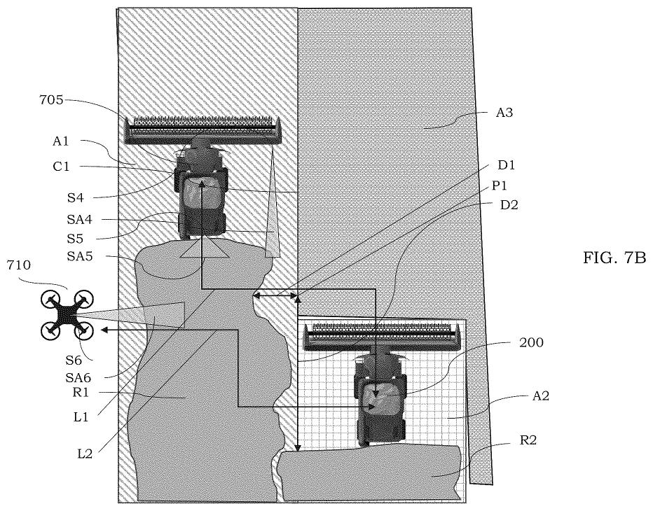

According to some example embodiments, the agricultural harvester 200 may obtain the residue spread variance by sensing the distance D1 between the spread width of the first residue R1 and the cut edge C1 using one or more forward-looking sensors on the agricultural harvester 200 (discussed further in connection with FIGS. 5A and 5B below). According to some example embodiments, the agricultural harvester 200 may obtain a map indicating the residue spread variance from another agricultural harvester 100 or another machine/device (e.g., a drone, etc.), or may generate the map (discussed further in connection with FIGS. 6A and 6B below). According to some example embodiments, the agricultural harvester 200 may obtain the residue spread variance in a first signal transmitted from another agricultural harvester 100 that harvests the first harvesting area A1 and spreads the first residue R1 (discussed further in connection with FIGS. 7A and 7B below).

According to some example embodiments, operation 210 may include obtaining the residue spread variance, a first value of at least one first environmental parameter corresponding to the residue spread variance (e.g., at a residue spread location of the first residue R1), and/or a second value of at least one second environmental parameter corresponding to a current environmental condition experienced at the agricultural harvester 200. For example, each of the at least one first environmental parameter and the at least one second environmental parameter may include a wind speed and/or direction, a terrain slope and/or pitch, a feedrate, and/or a moisture amount of a crop (may be collectively referred to as environmental parameters herein). The at least one first environmental parameter may correspond to an environmental condition experienced at a location (e.g., the residue spread location) in the first harvesting area A1 associated with the residue spread variance (e.g., at or near a portion of the first harvesting area A1 perpendicular to, or substantially perpendicular to, the first position P1 of the cut edge C1, and at the time when the first residue R1 was spread at the location of the first harvesting area A1).

At operation 220, the agricultural harvester 200 may determine an adjustment to at least one operation parameter of the agricultural harvester 200 to compensate for the residue spread variance obtained in operation 210. According to some example embodiments, the at least one operation parameter may include a speed of the spreader 142, a shroud/vane angle of the spreader 142, a speed of the chopper 140, a counter knife position of the chopper 140, a feedrate of the agricultural harvester 200 (e.g., by modifying a travel speed of the agricultural harvester 200, a height of the header 102, etc.), and/or a speed of the threshing rotor 112. Through adjustment of the at least one operation parameter, the agricultural harvester 200 may control the spread width of the second residue R2 to compensate for the residue spread variance. For example, the agricultural harvester 200 may widen the spread width of the second residue R2 to compensate for a larger distance D1, or narrow the spread width of the second residue R2 to compensate for a negative distance D1 (as discussed further above).

According to some example embodiments, the agricultural harvester 200 may adjust the at least one operation parameter based on the residue spread variance with reference to a table (e.g., stored in the memory 820). For example, as discussed above, the residue spread variance may correspond to (e.g., indicate, be used to determine, etc.) the first distance D1. As such, the residue spread variance may represent an amount by which a residue spread of the agricultural harvester 200 should change (e.g., widen or narrow) to compensate for the residue spread variance. The table may store associations between respective residue spread variance values and corresponding operation parameter adjustments. Each corresponding operation parameter adjustment may change (e.g., widen or narrow) the residue spread of the agricultural harvester 200 to compensate for the respective residue spread variance value (e.g., the distance D1). Accordingly, for any given value of residue spread variance the agricultural harvester 200 may identify one or more associated operation parameter adjustments, and adjust the at least one operation parameter consistent with the identified one or more operation parameter adjustments.

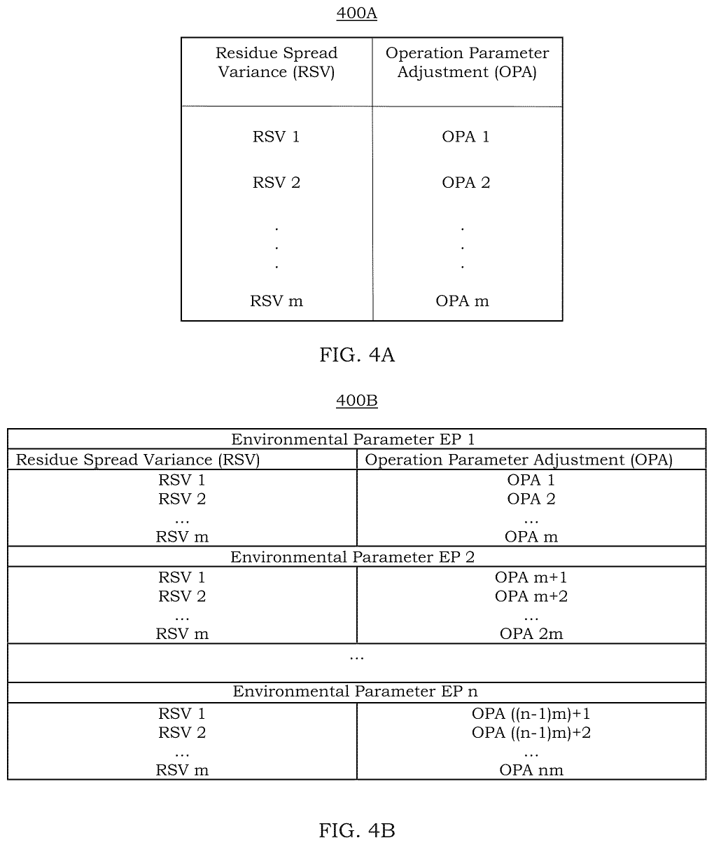

For example, FIG. 4A illustrates a table 400A containing associations between respective residue spread variance values and corresponding operation parameter adjustments, according to some example embodiments. With reference to FIG. 4A, the table 400A may store a plurality of operation parameter adjustments OPA 1, OPA 2, . . . OPA m in association with corresponding residue spread variance values RSV 1, RSV 2, . . . RSV m (where m is an integer having a value of 3 or more). Each of the operation parameter adjustments OPA 1, OPA 2, . . . OPA m may be associated with an adjustment to at least one operation parameter of the agricultural harvester 200. According to some example embodiments, the degree of granularity of the information contained in the table 400A may be a design parameter determined through empirical study. According to some example embodiments, each of the operation parameter adjustments OPA 1, OPA 2, . . . , OPA m may be associated with only one of the corresponding residue spread variance values RSV 1, RSV 2, . . . RSV m. According to some example embodiments, each of the operation parameter adjustments OPA 1, OPA 2, . . . , OPA m may be associated with one or more of the corresponding residue spread variance values RSV 1, RSV 2, . . . RSV m. According to some example embodiments, the table 400A may include only the operation parameter adjustments OPA 1, OPA 2, . . . , OPA m and the corresponding residue spread variance values RSP 1, RSP 2, . . . RSP m, but some example embodiments are not limited thereto.

Referring back to FIGS. 2-3, according to some example embodiments, the information contained in the table may be previously generated (e.g., by an expert user, manufacturer, etc.). According to some example embodiments, the information in the table may be generated and/or updated by the agricultural harvester 200. For example, the agricultural harvester 200 may train a machine learning model using reference training data. The reference training data may include, for example, reference residue spread variance values and corresponding reference operation parameter adjustments. According to some example embodiments, the reference operation parameter adjustments may include adjustments to one or more operation parameters for compensating the corresponding reference residue spread variance values to within a threshold level of residue spread variance (e.g., a threshold distance). The agricultural harvester 200 may train the machine learning model until the machine learning model outputs one or more operation parameter adjustments, in response to input of a corresponding residue spread variance value, that correct the corresponding residue spread variance value to within the threshold level of residue spread variance at a threshold level of consistency. For example, as discussed further above, the residue spread variance may correspond to (e.g., indicate, be used to determine, etc.) the first distance D1. The training of the machine learning model may include determining a spread distance change resulting from one or more operation parameters, and determining a degree of correspondence between the spread distance change and a corresponding reference residue spread variance value (e.g., a difference between the spread distance change and the first distance D1). A degree of correspondence within the threshold level of residue spread variance may be interpreted as a positive result, and a degree of correspondence outside of the threshold level of residue spread variance may be interpreted as a negative result. According to some example embodiments, the threshold level of residue spread variance and/or the threshold level of reliability may be design parameters determined through empirical study.

According to some example embodiments, the agricultural harvester 200 may update the trained machine learning model based on settings of the at least one operation parameter and another residue spread variance value. According to some example embodiments, the other residue spread variance value may correspond to a distance between the spread width of the first residue R1 and the spread width of the second residue R2 after the agricultural harvester 200 spreads the second residue R2 at the first position P1. According to some example embodiments, the other residue spread variance value may be detected by the agricultural harvester 200 (e.g., using the one or more residue sensors 835 discussed in association with FIG. 8), by another agricultural harvester 100, or by another machine/device (e.g., a drone, etc.). In this scenario, a degree of correspondence (e.g., the other residue spread variance) within the threshold level of residue spread variance may be interpreted as a positive result, and a degree of correspondence outside of the threshold level of residue spread variance may be interpreted as a negative result. According to some example embodiments, the machine learning model may be initially trained by a different device from the agricultural harvester 200 (e.g., by an external server), received by the agricultural harvester 200, and subsequently updated according to the other residue spread variance value during operation of the agricultural harvester 200.

In some example embodiments, the machine learning model may be implemented as an artificial neural network that is trained on a set of training data (e.g., the reference training data described above) by, for example, a supervised, unsupervised, and/or reinforcement learning model, and wherein the processing circuitry of the agricultural harvester 200 (e.g., the processing circuitry 810 discussed in association with FIG. 8) may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry of the agricultural harvester 200 may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

According to some example embodiments, the agricultural harvester 200 may adjust the at least one operation parameter based on the residue spread variance and the second value of the at least one second environmental parameter obtained in operation 210 (corresponding to a current environmental condition experienced at the agricultural harvester 200). For example, the table may store associations between respective residue spread variance values, corresponding operation parameter adjustments and corresponding environmental parameters. According to some example embodiments, the agricultural harvester 200 may include at least one environmental sensor (e.g., the at least one environmental sensor 825 discussed in association with FIG. 8) to sense values of the at least one environmental parameter corresponding to environmental conditions experienced at the agricultural harvester 200. According to some example embodiments, the reference training data used to train the machine learning model may include, for instance, reference residue spread variance values, reference environmental parameters and corresponding reference operation parameter adjustments. The reference operation parameter adjustments may include adjustments to the at least one operation parameter sufficient to correct the corresponding reference residue spread variance values to within the threshold level of residue spread variance under environmental conditions reflected by the reference environmental parameters.

According to some example embodiments, the agricultural harvester 200 may update the trained machine learning model based on settings of the at least one operation parameter during spreading of the first residue R1, the residue spread variance, and the first value of the at least one first environmental parameter. Thereby, the agricultural harvester 200 may use the residue spread variance to update the machine learning model during operation of the agricultural harvester 200.

By taking into account environmental parameters, the trained machine learning model may provide an operation parameter adjustment(s) that account for changes in environmental parameters. In a first scenario, for example, when the first value of the at least one first environmental parameter obtained in operation 210 indicates that the first residue R1 was spread by an agricultural harvester (e.g., the agricultural harvester 200 or another agricultural harvester 100) traveling on side sloping terrain (e.g., the first residue R1 was spread uphill), then an adjustment of the at least one operation parameter (e.g., an extension of the spread width of the second residue R2) may be reduced to account for a downhill spread. In a second scenario, for example, when the first value of the at least one first environmental parameter obtained in operation 210 indicates that a feedrate corresponding to the first residue R1 was substantially lower than a current feedrate of the agricultural harvester 200, an adjustment of the at least one operation parameter (e.g., an extension of the spread width of the second residue R2) may be reduced.

For example, FIG. 4B illustrates a table 400B containing associations between operation parameter adjustments and both residue spread variance values and environmental parameters, according to some example embodiments. With reference to FIG. 4B, the table 400B may store a plurality of operation parameter adjustments (OPA 1, OPA 2, . . . OPA m (where m is an integer having a value of 3 or more), OPA m+1, OPA m+2 . . . OPA 2m, OPA ((n−1)m)+1, OPA ((n−1)m)+2 . . . OPA nm (where n is an integer having a value of 3 or more, and may be equal to or different from m)) in association with both (1) corresponding residue spread variance values (RSV 1, RSV 2, . . . RSV m), and (2) corresponding environmental parameters (EP 1, EP 2 . . . EP n). Each of the operation parameter adjustments may be associated with an adjustment to at least one operation parameter of the agricultural harvester 200. Each of the environmental parameters may be associated with a value of the at least one environmental parameter (e.g., the second value of the at least one second environmental parameter) discussed herein. According to some example embodiments, the degree of granularity of the information contained in the table 400B may be a design parameter determined through empirical study. According to some example embodiments, each of the operation parameter adjustments may be associated with only one of the corresponding residue spread variance values and/or environmental parameters. According to some example embodiments, each of the operation parameter adjustments may be associated with one or more of the corresponding residue spread variance values and/or environmental parameters. According to some example embodiments, the table 400B may include only the operation parameter adjustments, the corresponding residue spread variance values and the environmental parameters, but some example embodiments are not limited thereto.

At operation 230, the agricultural harvester 200 may perform a residue spread operation to spread the second residue R2 at the first position P1 using the adjusted at least one operation parameter to compensate for the residue spread variance in the first harvesting area A1. Through such compensation, the agricultural harvester 200 may provide for improvements in residue spread coverage and/or distribution across the first harvesting area A1 and the second harvesting area A2. According to some example embodiments, the agricultural harvester 200 may perform the residue spread operation at the first position P1 taking into account a time duration for the agricultural harvester 200 to travel (e.g., based on a travel speed of the agricultural harvester 200) between a location of the agricultural harvester 200 when the at least one operation parameter is adjusted and the first position P1. According to some example embodiments, the distance between the location of the agricultural harvester 200 and the first position P1, and/or the travel speed of the agricultural harvester 200) may be determined using the geo-positioning device 830 discussed in association with FIG. 8 below.

According to some example embodiments, the agricultural harvester 200 may repeat (e.g., continuously) the operations 210, 220 and/or 230 to provide periodic or continuous operation parameter adjustment and corresponding residue spread variance compensation of an adjacent harvesting area (e.g., the first harvesting area A1). The operations 210, 220 and/or 230 may be repeated until the agricultural harvester 200 reaches an end of the row in the field, or terminates residue spreading operation in the field.

FIG. 5A illustrates a flowchart of a method for obtaining a residue spread variance by determining a distance between a residue spread width and a cut edge using forward-looking sensors, according to some example embodiments. FIG. 5B illustrates a diagram showing the determining performed using the forward-looking sensors, according to some example embodiments.

Referring to FIGS. 5A and 5B, in operation 212A, the agricultural harvester 200 may determine an edge of the spread width of the first residue R1, and the cut edge C1 of the first harvesting area A1 (e.g., positions of the spread width and cut edges), from the second harvesting area A2. According to some example embodiments, the agricultural harvester may have one or more sensors (e.g., the one or more residue sensors 835 discussed in association with FIG. 8) for use in sensing the edge of the spread width of the first residue R1, and the cut edge C1 of the first harvesting area A1 (while termed “residue sensors” herein, the one or more residue sensors 835, the one or more residue sensors 865 and the residue sensors 895, as discussed in association with FIG. 8, may be configured to sense both the spread width of the first residue R1 and the cut edge C1), but some example embodiments are not limited thereto. According to some example embodiments, the edge of the spread width of the first residue R1, and the cut edge C1 of the first harvesting area A1, may be obtained from a coverage map, etc. The one or more sensors (e.g., the one or more residue sensors 835, the one or more residue sensors 865 and the residue sensors 895 as discussed in association with FIG. 8) may include at least one camera, a Radar system, a Lidar system, etc. According to some example embodiments, the at least one camera may detect visible light (e.g., red, green and blue light), infrared light (e.g., thermal imaging), etc. According to some example embodiments, the one or more sensors may be forward-directed and positioned on a front end of the agricultural harvester 200 (e.g., a first sensor S1). According to some example embodiments, the one or more sensors may be sideways-directed and positioned on a side of the agricultural harvester 200 (e.g., a second sensor S2 and a third sensor S3). According to some example embodiments, the first sensor S1 may be implemented by the forward looking image capture mechanism 151, and each of the second sensor S2 and the third sensor S3 may be implemented using the at least one sideways looking image capture mechanism 153. According to some example embodiments, each of the one or more sensors may have a corresponding sensing area. For example, the first sensor S1 may have a first sensing area SA1, the second sensor S2 may have a second sensing area SA2, and the third sensor S3 may have a third sensing area SA3. According to some example embodiments, the one or more sensors may include both at least one forward-directed sensor and at least one sideways-directed sensor (e.g., the first sensor S1, the second sensor S2 and the third sensor S3). According to some example embodiments, the one or more sensors may sense the edge of the spread width of the first residue R1 based on the residue spread on the ground and/or based on the residue spread in the air. As may be appreciated from the above discussion and the illustration in FIG. 3, both the forward-directed sensor(s) and sideways-directed sensor(s) may be considered as forward-looking sensors with respect to the spreader 142 at the rear end of the agricultural harvester 200.

In operation 214A, the agricultural harvester 200 may compute a residue spread variance (e.g., the first distance D1) at a position along the cut edge C1 (e.g., the first position P1), for example, based on the determined (1) edge of the spread width of the first residue R1 and (2) cut edge C1 of the first harvesting area A1. For example, the agricultural harvester 200 may compute the distance between the determined (1) edge of the spread width of the first residue R1 and (2) cut edge C1 of the first harvesting area A1. According to some example embodiments, the agricultural harvester 200 may repeat the operations 212A and 214A periodically to obtain a residue spread variance including the plurality of distances D1 respectively corresponding to distances between the cut edge C1 and the edge of the spread width of the first residue R1. According to some example embodiments, the agricultural harvester 200 may repeat the operations 212A and 214A continuously (e.g., in real-time) to obtain a residue spread variance including the continuous curve indicative of the varying distances D1 between the cut edge C1 the edge of the spread width of the first residue R1.

According to some example embodiments, in operation 230, the agricultural harvester 200 may perform the residue spread operation at the position along the cut edge corresponding to the computed residue spread variance (e.g., the first position P1) taking into account the duration for the agricultural harvester 200 to travel (e.g., based on a travel speed of the agricultural harvester 200) between a location of the agricultural harvester 200 when the at least one operation parameter is adjusted and the first position P1.

FIG. 6A illustrates a flowchart of a method for obtaining a residue spread variance using a residue spread variance map, according to some example embodiments. FIG. 6B illustrates a diagram showing the generation and use of the residue spread variance map, according to some example embodiments.

Referring to FIGS. 6A and 6B, a residue spread variance map may be generated. According to some example embodiments, the residue spread variance map may be generated by an agricultural harvester 605, that spreads the first residue R1, using rearward-directed sensors on the agricultural harvester 605 (e.g., the one or more residue sensors 835 or the one or more residue sensors 865 discussed in association with FIG. 8). The agricultural harvester 605 may be the same as (or similar to) the agricultural harvester 200 that subsequently spreads the second residue R2, or the agricultural harvester 605 may be a different agricultural harvester 100. The agricultural harvester 605 may have one or more sensors for use in sensing the edge of the spread width of the first residue R1, and the cut edge C1 of the first harvesting area A1, but some example embodiments are not limited thereto. According to some example embodiments, the edge of the spread width of the first residue R1, and the cut edge C1 of the first harvesting area A1, may be obtained from a coverage map, etc. The one or more sensors of the agricultural harvester 605 may be the same as, or similar to, the one or more sensors of the agricultural harvester 200 (discussed in connection with operation 212A) except being rearward-directed (e.g., a fourth sensor S4 and/or a fifth sensor S5) rather than forward-directed or sideways-directed. According to some example embodiments, the fourth sensor S4 and/or the fifth sensor S5 may be implemented by the rearward looking image capture mechanism 151. According to some example embodiments, each of the one or more sensors may have a corresponding sensing area. For example, the fourth sensor S4 may have a fourth sensing area SA4, and the fifth sensor S5 may have a fifth sensing area SA5. According to some example embodiments, the agricultural harvester 605 may also include at least one environmental sensor (e.g., the at least one environmental sensor 825 or the at least one environmental sensor 855 discussed in association with FIG. 8, to sense values of the at least one environmental parameter discussed in connection with FIGS. 2-3 above), and/or a geo-positioning device (e.g., a GPS receiver, for instance, the geo-positioning device 830 or the geo-positioning device 860 discussed in connection with FIG. 8).

According to some example embodiments, the residue spread variance map may be generated by another machine/device capable of observing the first harvesting area A1 and generating the residue spread variance map. Hereinafter, the other machine/device is referred to as a drone 610; however, some example embodiments are not limited thereto, and the other machine/device may be any other machine or device capable of observing the first harvesting area A1 and generating the residue spread variance map. For example, the other machine/device may be an autonomous flying vehicle, a manned flying vehicle, a remotely operated flying vehicle, an autonomous land vehicle, a manned land vehicle, a remotely operated land vehicle, a satellite, etc. The drone 610 may have one or more sensors for use in sensing the edge of the spread width of the first residue R1, and the cut edge C1 of the first harvesting area A1 (e.g., the one or more residue sensors 835 discussed in connection with FIG. 8), but some example embodiments are not limited thereto. According to some example embodiments, the edge of the spread width of the first residue R1, and the cut edge C1 of the first harvesting area A1, may be obtained from a coverage map, etc. The one or more sensors of the drone 610 (e.g., a sixth sensor S6 having a corresponding sixth sensing area SA6) may be the same as, or similar to, the one or more sensors of the agricultural harvester 200 (discussed in connection with operation 212A) except being groundward-directed rather than forward-directed or sideways-directed. According to some example embodiments, the drone 610 may also include at least one environmental sensor (e.g., the at least one environmental sensor 885 discussed in connection with FIG. 8, to sense values of the at least one environmental parameter discussed in connection with FIGS. 2-3 above), and/or a geo-positioning device (e.g., a GPS receiver, for instance, the geo-positioning device 890 discussed in connection with FIG. 8).

In operation 212B, the agricultural harvester 605 (or the drone 610) may determine the edge of the spread width of the first residue R1, and the cut edge C1 of the first harvesting area A1, using the one or more sensors. According to some example embodiments, the agricultural harvester 605 (or the drone 610) may also detect a value(s) of the at least one environmental parameter at a residue spread location in the first harvesting area A1 at which the spread width of the first residue R1, and the cut edge C1 of the first harvesting area A1, are determined using the at least one environmental sensor. According to some example embodiments, the agricultural harvester 605 (or the drone 610) may also detect the residue spread location in the first harvesting area A1 at which the spread width of the first residue R1, and the cut edge C1 of the first harvesting area A1, are determined using the geo-positioning device. For example, the agricultural harvester 605 may detect a current location of the agricultural harvester 605 (or a location offset from the current location of the agricultural harvester 605 as representative of the location of the spreader 142 or the first residue R1), using the geo-positioning device, as the residue spread location. For example, the drone 610 may detect a current location of the drone 610, using the geo-positioning device, and offset the current location according to a ground distance to the location of the spreader 142 or the first residue R1, to obtain the residue spread location.

In operation 214B, the agricultural harvester 605 (or the drone 610) may compute a residue spread variance (e.g., the first distance D1) at a position along the cut edge C1 (e.g., the first position P1), for example, based on the determined (1) edge of the spread width of the first residue R1 and (2) cut edge C1 of the first harvesting area A1. For example, the agricultural harvester 605 (or the drone 610) may compute the distance between the sensed (1) edge of the spread width of the first residue R1 and (2) cut edge C1 of the first harvesting area A1. According to some example embodiments, the agricultural harvester 605 (or the drone 610) may repeat the operations 212B and 214B periodically to obtain a residue spread variance including the plurality of distances D1 respectively corresponding to distances between the cut edge C1 and the edge of the spread width of the first residue R1. According to some example embodiments, the agricultural harvester 605 (or the drone 610) may repeat the operations 212B and 214B continuously (e.g., in real-time) to obtain a residue spread variance including the continuous curve indicative of the varying distances D1 between the cut edge C1 the edge of the spread width of the first residue R1.

In operation 216B, the agricultural harvester 605 (or the drone 610) may generate a residue spread variance map including the computed residue spread variance. According to some example embodiments, computed residue spread variance is included on the map in association with (1) the detected residue spread location and/or (2) the value(s) of the at least one environmental parameter at the residue spread location. According to some example embodiments, the residue spread variance map may include the residue spread variance, having the plurality of distances D1 or the continuous curve (also referred to herein as residue spread variance value(s)), on the map in association with (1) respective residue spread locations and/or (2) respective values of the at least one environmental parameter at each of the residue spread locations. The agricultural harvester 200 may obtain the generated residue spread variance map before, or contemporaneous with, performing residue spread operation (e.g., to spread the second residue R2). According to some example embodiments, when map is generated by the agricultural harvester 605, implemented as a different agricultural harvester 100 from the agricultural harvester 200, the agricultural harvester 605 may transmit the residue spread variance map to the agricultural harvester 200 via a first communication link (e.g., the first communication link L1, transmitted via the transceiver 845 and received via the transceiver 815, as discussed in association with FIG. 8). According to some example embodiments, when map is generated by the drone 610, the drone 610 may transmit the residue spread variance map to the agricultural harvester 200 via a second communication link (e.g., the second communication link L2, transmitted via the transceiver 875 and received via the transceiver 815, as discussed in association with FIG. 8). According to some example embodiments, each of the first communication link and the second communication link may be any suitable type of communication link. For example, the communication link may be an Ethernet link, an 802.11 (WiFi) link, a Radio Frequency (RF) (e.g., cellular) link, a Transmission Control Protocol/Internet Protocol (TCP/IP) link, a Universal Serial Bus (USB) link, a Bluetooth™ link, or any combination thereof.

According to some example embodiments, in operation 220, the agricultural harvester 200 may adjust the at least one operation parameter based on the residue spread variance value at the corresponding residue spread location(s) as indicated on the residue spread variance map. For example, the agricultural harvester 200 may adjust the at least one operation parameter based on (1) the residue spread variance value at a residue spread location (e.g., the first position P1), and (2) a current value(s) of the at least one environmental parameter sensed by the agricultural harvester 200 in the second harvesting area A2 (e.g., the at least one second environmental parameter), through reference to the table 400B discussed in connection with FIG. 4B.

According to some example embodiments, in operation 230, the agricultural harvester 200 may perform the residue spread operation at one or more of the residue spread locations corresponding to the computed residue spread variance value(s) (e.g., the first position P1), as indicated on the residue spread variance map, taking into account the duration for the agricultural harvester 200 to travel (e.g., based on a travel speed of the agricultural harvester 200) between a location of the agricultural harvester 200 when the at least one operation parameter is adjusted and the residue spread locations. According to some example embodiments, the operations 212B, 214B and/or 216B may be performed before the agricultural harvester 200 begins spreading the second residue R2, but some example embodiments are not limited thereto.

FIG. 7A illustrates a flowchart of a collaborative method for obtaining a residue spread variance, according to some example embodiments. FIG. 7B illustrates a diagram showing determining and communication of the residue spread variance, according to some example embodiments.

In operation 212C, the agricultural harvester 705 (or the drone 710) may determine the edge of the spread width of the first residue R1, and the cut edge C1 of the first harvesting area A1, using the one or more sensors (e.g., the one or more residue sensors 865 or the one or more residue sensors 895 discussed in association with FIG. 8). According to some example embodiments, the agricultural harvester 705 may be the same as, or similar to, the agricultural harvester 605 discussed in connection with FIGS. 6A-6B. The agricultural harvester 705 may be a different agricultural harvester 100 from the agricultural harvester 200. Hereinafter, the agricultural harvester 200 may be described as a first agricultural harvester 200, and the agricultural harvester 705 may be described as a second agricultural harvester 705 for added clarity. According to some example embodiments, the drone 710 may be the same as, or similar to, the drone 610 discussed in connection with FIGS. 6A-6B. Redundant description between that associated with FIGS. 6A-6B and that associated with FIGS. 7A-7B may be omitted.

According to some example embodiments, the second agricultural harvester 705 (or the drone 710) may also detect a value(s) of the at least one environmental parameter at a residue spread location in the first harvesting area A1 at which the spread width of the first residue R1, and the cut edge C1 of the first harvesting area A1, are determined using the at least one environmental sensor. According to some example embodiments, the second agricultural harvester 705 (or the drone 710) may also detect the residue spread location in the first harvesting area A1 at which the spread width of the first residue R1, and the cut edge C1 of the first harvesting area A1, are determined using the geo-positioning device. For example, the second agricultural harvester 705 may detect a current location of the second agricultural harvester 705 (or a location offset from the current location of the second agricultural harvester 705 as representative of the location of the spreader 142 or the first residue R1), using the geo-positioning device, as the residue spread location. For example, the drone 710 may detect a current location of the drone 710, using the geo-positioning device, and offset the current location according to a ground distance to the location of the spreader 142 or the first residue R1, to obtain the residue spread location.

In operation 214C, the second agricultural harvester 705 (or the drone 710) may compute a residue spread variance (e.g., the first distance D1) at a position along the cut edge C1 (e.g., the first position P1), for example, based on the determined (1) edge of the spread width of the first residue R1 and (2) cut edge C1 of the first harvesting area A1. For example, the second agricultural harvester 705 (or the drone 710) may compute the distance between the determined (1) edge of the spread width of the first residue R1 and (2) cut edge C1 of the first harvesting area A1.

In operation 216C, the second agricultural harvester 705 (or the drone 710) may transmit a first signal to the first agricultural harvester 200 indicating the computed residue spread variance. For example, the second agricultural harvester 705 may transmit the first signal via the first communication link L1 (e.g., transmitted via the transceiver 845 and received via the transceiver 815, as discussed in association with FIG. 8). For example, the drone 710 may transmit the first signal via the second communication link L2 (e.g., transmitted via the transceiver 875 and received via the transceiver 815, as discussed in association with FIG. 8). According to some example embodiments, the first signal may indicate (e.g., include) the computed residue spread variance in association with (1) the detected residue spread location and/or (2) the value of the at least one environmental parameter at a residue spread location (e.g., the at least one first environmental parameter).

According to some example embodiments, the second agricultural harvester 705 (or the drone 710) may repeat the operations 212C, 214C and/or 216C periodically to obtain a residue spread variance including the plurality of distances D1 respectively corresponding to distances between the cut edge C1 and the edge of the spread width of the first residue R1. According to some example embodiments, the second agricultural harvester 705 (or the drone 710) may repeat the operations 212C, 214C and/or 216C continuously (e.g., in real-time) to provide a residue spread variance including the continuous curve indicative of the varying distances D1 between the cut edge C1 the edge of the spread width of the first residue R1.

According to some example embodiments, simultaneous or contemporaneous with the performance of the operations 212C, 214C and/or 216C, with respect to first residue R1 being spread in the first harvesting area A1 by the second agricultural harvester 705 (or the drone 710), the first agricultural harvester 200 may perform residue spread operations to spread the second residue R2. For example, the second agricultural harvester 705 may spread the first residue R1 in the first harvesting area A1, and the first agricultural harvester 200 may spread the second residue R2, at the same time or contemporaneously. The second agricultural harvester 705 (or the drone 710) may perform the operations 212C, 214C and/or 216C at the same time as, or contemporaneously with, the spreading of the first residue R1 by the second agricultural harvester 705. According to some example embodiments, the first agricultural harvester 200 may spread the second residue R2 while traveling in the same direction as, or a different direction from (e.g., an opposite direction), that being traveled by the second agricultural harvester 705 while the second agricultural harvester 705 spreads the first residue R1. According to some example embodiments, the second agricultural harvester 705 and the first agricultural harvester 200 may be at least the threshold distance apart in a direction parallel, or substantially parallel, to a direction of travel of one or both of the first agricultural harvester 200 and/or the second agricultural harvester 705. This direction of travel may also be parallel to an alignment of the rows of the field, but some example embodiments are not limited thereto. According to some example embodiments, the second agricultural harvester 705 may perform the operations 212C, 214C and/or 216C in real-time to provide the first agricultural harvester 200 with prompt updates regarding the residue spread variance.

According to some example embodiments, in operation 220, the first agricultural harvester 200 may adjust the at least one operation parameter based on the residue spread variance value at the corresponding residue spread location(s) as indicated in the first signal. For example, the first agricultural harvester 200 may adjust the at least one operation parameter based on (1) the residue spread variance value at a residue spread location (e.g., the first position P1), and (2) a current value(s) of the at least one environmental parameter (e.g., the second value of the at least one second environmental parameter) sensed by the first agricultural harvester 200 in the second harvesting area A2, through reference to the table 400B discussed in connection with FIG. 4B.

According to some example embodiments, in operation 230, the first agricultural harvester 200 may perform the residue spread operation at one or more of the residue spread locations corresponding to the computed residue spread variance value(s) (e.g., the first position P1), as indicated in the first signal, taking into account the duration for the first agricultural harvester 200 to travel (e.g., based on a travel speed of the first agricultural harvester 200) between a location of the first agricultural harvester 200 when the at least one operation parameter is adjusted and the residue spread locations.

FIG. 8 is a diagram of a system for adjusting a residue spread to compensate for a residue spread variance, according to some example embodiments. The system may include the first agricultural harvester 200, the second agricultural harvester 705 and/or the drone 710, but some example embodiments are not limited thereto. According to some example embodiments, the system may include three or more agricultural harvesters 100, each of which is capable of performing operations consistent with those of the first agricultural harvester 200 and the second agricultural harvester 705, for example, at different times (or simultaneously or contemporaneously) and/or in collaboration with different agricultural harvesters 100 (or the same agricultural harvester 100). The first agricultural harvester 200 may include processing circuitry 810, a transceiver 815, a memory 820, at least one environmental sensor 825, a geo-positioning device 830, and/or one or more residue sensors 835. The second agricultural harvester 705 may include processing circuitry 840, a transceiver 845, a memory 850, at least one environmental sensor 855, a geo-positioning device 860, and/or one or more residue sensors 865. The drone 710 may include processing circuitry 870, a transceiver 875, a memory 880, at least one environmental sensor 885, a geo-positioning device 890, and/or one or more residue sensors 895. According to some example embodiments, the operations described herein as being performed by the agricultural harvester 605 may be performed by either the first agricultural harvester 200 or the second agricultural harvester 705. According to some example embodiments, the operations described herein as being performed by the drone 610 may be performed by the drone 710.

The first agricultural harvester 200 may connect to the second agricultural harvester 705 via the first communication link L1 (and may connect to another agricultural harvester 100 via another, similar communication link). Likewise, the second agricultural harvester 705 may connect to the first agricultural harvester 200 via the first communication link L1 (and may connect to another agricultural harvester 100 via another, similar communication link). The first agricultural harvester 200 may connect to the drone 710 via the second communication link L2 (and may connect to another agricultural harvester 100 via another, similar communication link). Likewise, the drone 710 may connect to the first agricultural harvester 200 via the second communication link L2 (and may connect to another agricultural harvester 100 via another, similar communication link).

According to some example embodiments, operations described herein as being performed by the agricultural harvester 100, the agricultural harvester 200, the agricultural harvester 605, the drone 610, the first agricultural harvester 200, the second agricultural harvester 705, and/or the drone 710 may be performed by processing circuitry (e.g., the processing circuitry 810, the processing circuitry 840 and/or the processing circuitry 870). According to some example embodiments, the transceiver 815, the at least one environmental sensor 825, the geo-positioning device 830, and the one or more residue sensors 835 may operate under the control of the processing circuitry 810. According to some example embodiments, the transceiver 845, the at least one environmental sensor 855, the geo-positioning device 860, and the one or more residue sensors 865 may operate under the control of the processing circuitry 840. According to some example embodiments, the transceiver 875, the at least one environmental sensor 885, the geo-positioning device 890, and the one or more residue sensors 895 may operate under the control of the processing circuitry 870. According to some example embodiments, at least some of the operations described herein as being performed by the agricultural harvester 100, the agricultural harvester 200, the agricultural harvester 605, the drone 610, the first agricultural harvester 200, the second agricultural harvester 705, and/or the drone 710 may be performed by remote processing circuitry (e.g., using one or more external servers) in respective communication with the agricultural harvester 100, the agricultural harvester 200, the agricultural harvester 605, the drone 610, the first agricultural harvester 200, the second agricultural harvester 705, and/or the drone 710.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 720 and the memory 770).

According to some example embodiments, the memory 820, the memory 850 and the memory 880 may each be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components (or parameters, values, etc.), the components (or parameters, values, etc.) are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

1. An agricultural harvester, comprising:
a spreader; and
processing circuitry configured to cause the agricultural harvester to,
obtain a residue spread variance of a first residue spread in a first harvesting area, the residue spread variance corresponding to a distance between an edge of the first residue and a first position of a cut edge of the first harvesting area, and the residue spread variance being obtained before the spreader reaches a second position in a second harvesting area, the second harvesting area being adjacent to the first harvesting area, and the first position being aligned with the second position,
adjust an operation parameter of the agricultural harvester based on the residue spread variance to obtain an adjusted operation parameter, and
control the agricultural harvester in the second harvesting area according to the adjusted operation parameter, the control of the agricultural harvester according to the adjusted operation parameter causing the spreader to spread a second residue at the second position to compensate for the residue spread variance.

2. The agricultural harvester of claim 1, wherein the processing circuitry is configured to cause the agricultural harvester to control the agricultural harvester according to the adjusted operation parameter such that the second residue is spread into the first harvesting area between the edge of the first residue and the cut edge.

3. The agricultural harvester of claim 1, wherein the processing circuitry is configured to cause the agricultural harvester to obtain the residue spread variance by sensing the residue spread variance using one or more sensors on the agricultural harvester, the one or more sensors including a sensor having a sensing area directed toward a front of the agricultural harvester.

4. The agricultural harvester of claim 1, wherein the processing circuitry is configured to cause the agricultural harvester to obtain the residue spread variance from a map.

5. The agricultural harvester of claim 4, wherein the processing circuitry is configured to cause the agricultural harvester to generate the map based on at least one residue spread variance value sensed using one or more sensors on the agricultural harvester.

6. The agricultural harvester of claim 4, wherein the processing circuitry is configured to cause the agricultural harvester to receive the map from another agricultural harvester or another machine.

7. The agricultural harvester of claim 4, wherein the processing circuitry is configured to cause the agricultural harvester to obtain the map before spreading the second residue.

8. The agricultural harvester of claim 1, wherein the processing circuitry is configured to cause the agricultural harvester to obtain the residue spread variance from a first signal received from another agricultural harvester or another machine.

9. The agricultural harvester of claim 8, wherein the processing circuitry is configured to cause the agricultural harvester to receive the first signal while spreading the second residue.

10. The agricultural harvester of claim 1, wherein the processing circuitry is configured to cause the agricultural harvester to adjust the operation parameter based on the residue spread variance and an environmental condition.

11. The agricultural harvester of claim 10, wherein the environmental condition corresponds to an environment at the agricultural harvester in the second harvesting area.

12. The agricultural harvester of claim 1, wherein the processing circuitry is configured to cause the agricultural harvester to adjust the operation parameter based on the residue spread variance based on a table, the table including a plurality of operation parameter adjustments stored in association with corresponding residue spread variance values.

13. The agricultural harvester of claim 12, wherein the table is generated based on a machine learning model trained using a plurality of reference residue spread variance values and a plurality of reference operation parameter adjustments, each of the plurality of operation parameter adjustments being an adjustment to the operation parameter sufficient to change a residue spread by a distance corresponding to an associated reference residue spread variance value among the plurality of reference residue spread variance values.

14. A non-transitory computer-readable medium storing instructions that, when executed by at least one processor of an agricultural harvester, cause the at least one processor to perform a method, the method comprising:
obtaining a residue spread variance of a first residue spread in a first harvesting area, the residue spread variance corresponding to a distance between an edge of the first residue and a first position of a cut edge of the first harvesting area, and the residue spread variance being obtained before a spreader of the agricultural harvester reaches a second position in a second harvesting area, the second harvesting area being adjacent to the first harvesting area, and the first position being aligned with the second position;
adjusting an operation parameter of the agricultural harvester based on the residue spread variance to obtain an adjusted operation parameter; and
controlling the agricultural harvester in the second harvesting area according to the adjusted operation parameter, the controlling causing the spreader to spread a second residue at the second position to compensate for the residue spread variance.

15. The non-transitory computer-readable medium of claim 14, wherein the controlling causes the spreader to spread the second residue into the first harvesting area between the edge of the first residue and the cut edge.

16. The non-transitory computer-readable medium of claim 14, wherein the obtaining the residue spread variance comprises sensing the residue spread variance using one or more sensors on the agricultural harvester, the one or more sensors including a sensor having a sensing area directed toward a front of the agricultural harvester.

17. The non-transitory computer-readable medium of claim 14, wherein the obtaining the residue spread variance comprises obtaining the residue spread variance from a map before the spreader spreads the second residue.

18. The non-transitory computer-readable medium of claim 14, wherein the obtaining the residue spread variance comprises obtaining the residue spread variance from a first signal received from another agricultural harvester or another machine.

19. A method performed by an agricultural harvester, the method comprising:
obtaining a residue spread variance of a first residue spread in a first harvesting area, the residue spread variance corresponding to a distance between an edge of the first residue and a first position of a cut edge of the first harvesting area, and the residue spread variance being obtained before a spreader of the agricultural harvester reaches a second position in a second harvesting area, the second harvesting area being adjacent to the first harvesting area, and the first position being aligned with the second position;
adjusting an operation parameter of the agricultural harvester based on the residue spread variance to obtain an adjusted operation parameter; and
controlling the agricultural harvester in the second harvesting area according to the adjusted operation parameter, the controlling causing the spreader to spread a second residue at the second position to compensate for the residue spread variance.

20. The method of claim 19, wherein the controlling causes the spreader to spread the second residue into the first harvesting area between the edge of the first residue and the cut edge.
